(19) United States
(12) Patent Application Publication
(10) Pub. No.: US 2006/0031081 A1
(43) Pub. Date: Feb. 9, 2006

(54) Method and apparatus for information storage, customization and delivery at a service-delivery site such as a beauty salon

(76) Inventor: Jon F. Arne, Plymouth, MN (US)

Correspondence Address: LEMAIRE PATENT LAW FIRM, P.L.L.C., PO BOX 11358, ST PAUL, MN, 55111, US

(21) Appl. No.: 10/912,026

(22) Filed: Aug. 4, 2004

(51) Int. Cl. G06Q 99/00

(52) U.S. Cl. 705/1

(57) ABSTRACT

A method and apparatus is presented for information storage, selection, customization, presentation-timing and delivery at a service-delivery site, such as a hair-style or beauty salon. Customer-specific information (e.g., personal-grooming product preferences, recommendations, and photographs of past haircuts) is stored, retrieved, timed, and displayed or otherwise output for presentation to the customer at the service-delivery site. For example, a salon provides each customer a portable memory unit onto which is stored one or more photographs of that customer showing past haircuts, and optional preferences as to auxiliary services or products to be provided during a visit. The customer and stylist can review photographs of past hair cuts and stylings and specify any changes desired. After completing the styling and/or other services, photographs are taken and stored for future visits. Optionally, customized entertainment and advertising content is provided based on customer-specified and stored preferences.

### FIELD OF THE INVENTION

This invention relates to the field of computer-aided customer service, and more particularly to a method and apparatus for information storage, customization and delivery at a service-delivery site such as a hair-style or beauty salon, wherein customer-specific information (such as personal-grooming product preferences and recommendations, entertainment preferences, and, e.g., photographs of past haircuts) is entered, stored, retrieved, timed, and displayed or otherwise output for presentation to the customer at the service-delivery site.

### BACKGROUND OF THE INVENTION

Most beauty salon customers would like a more certain outcome when getting their hair cut and styled, or acquiring other beauty salon services. Moreover, many customers have a desire to replicate, accentuate, or alter a specific service relative to the results of a previous salon visit. Typically, verbal communication between the customer and stylist (e.g., “Please take about 1½ inches off the top, layer the sides sort of ragged with a little undercut, leave the bangs, dapple some highlights, don't use the stuff they used last time because it ends up red, etc.), or reference to a photograph of someone else's haircut is the only attempted communication to convey the end result(s) that the customer desires. This is particularly true of newer customers, whose requirements would then have to be remembered by the service provider. For repeat customers who are infrequent visitors, the service provider most likely will need his or her memory refreshed regarding the customer's requirements. If the current service provider is different than the previous stylist, then a complete recitation of the customer's requirements and preferences must be provided. Further, during the styling session, the customer is typically subjected to the ramblings of the stylist, mixed with the general ambient chatter, and perhaps some audio programs from a local radio station. Finally, once the services are rendered, there is no clear and efficient mechanism for remembering the results of the service and the customer's feedback. Thus, there is a need for an improved method and apparatus to aid in providing personal services, such as hair styling, personal grooming, and other services.

### SUMMARY OF THE INVENTION

In some embodiments, the present invention provides a method and apparatus for information storage, selection, customization, presentation-timing and delivery at a service-delivery site, such as a hair-style or beauty salon, wherein customer-specific information (e.g., personal-grooming product preferences, recommendations, and/or photographs of past haircuts) is entered, stored, retrieved, timed, and displayed or otherwise output for presentation to the customer at the service-delivery site.

### BRIEF DESCRIPTION OF THE DRAWINGS

FIG. 1 shows a schematic representation of a fashion-file system 100 of one embodiment of the present invention.

FIG. 2 shows a schematic representation of a service station or styling booth 110 of one embodiment of the present invention.

FIG. 3 shows a schematic representation of a server 140 of one embodiment of the present invention.

FIG. 4 shows a schematic representation of a customer information model 122 of one embodiment of the present invention.

FIG. 5 is a flowchart of a method 500 used in some embodiments of the invention.

### DETAILED DESCRIPTION

In the following detailed description that includes the preferred embodiments, reference is made to the accompanying drawings that form a part hereof, and in which are shown by way of illustration specific embodiments in which the invention may be practiced. It is understood that other embodiments may be utilized and structural changes may be made without departing from the scope of the present invention.

The leading digit(s) of reference numbers appearing in the Figures generally corresponds to the Figure number in which that component is first introduced, such that the same reference number is used throughout to refer to an identical component which appears in multiple Figures. Signals and connections may be referred to by the same reference number or label, and the actual meaning will be clear from its use in the context of the description.

Personal service sites, such as styling booths at a beauty salon, are typically customized to some extent in order to provide specific services, such as hair cutting, washing, dyeing, bleaching, styling, drying, and/or other chemical treatment processes. Some salons also provide services such as skin cleansing and care, nail salon services, and/or foot or back massages. To provide profit to the salon and value to the customer, it is desirable to make the operation as speedy and efficient as possible, yet listen to the customer for their needs and retain an unhurried, relaxing, stress-free, and entertaining environment. Further, it is desirable to increase salon business by selling and providing additional services and products, such as nail-strengthening compositions, new methods for styling hair, cosmetic compositions, cosmetic-remover compositions, moisturizing cosmetic-stick compositions, hair-dye compositions and processes, hair-conditioning compositions, hair-bleach compositions, gel cosmetic compositions, semi-matte finishes or glossy, transfer-resistant lipstick compositions, high-lustre lipstick compositions, pore-cleansing strips, methods and compositions for treating chapped lips, pigments and colors in cosmetics, mascara compositions and methods for curling lashes, water-in-oil microemulsion compositions, and/or methods for removing dead surface cells, dirt, oil, and blackheads from the skin.

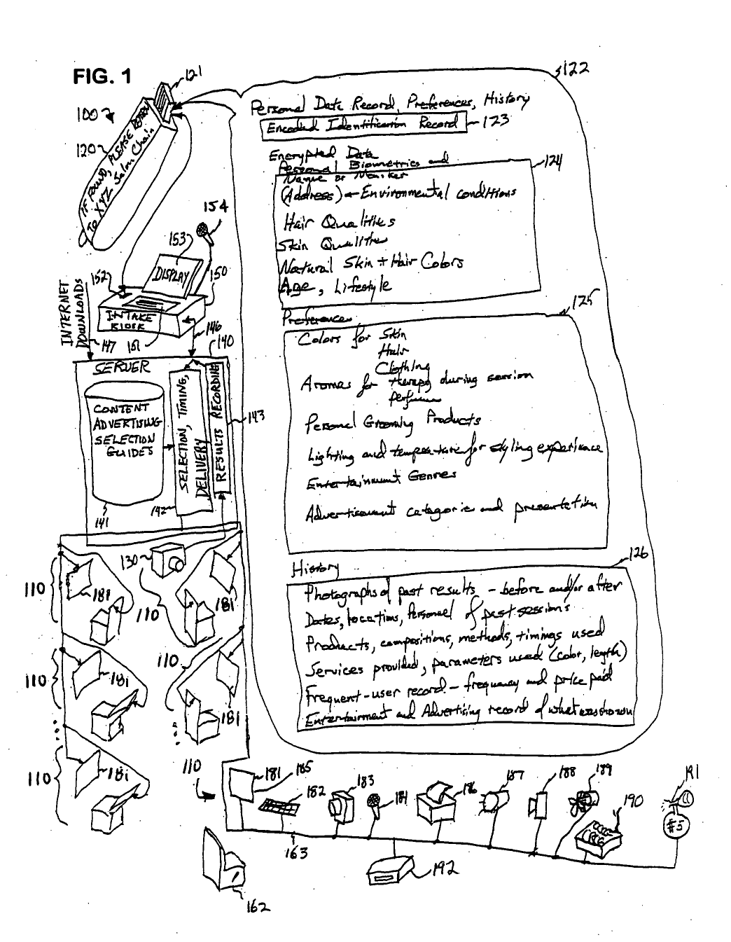

FIG. 1 shows a schematic representation of a fashion-file system 100 according to some embodiments of the invention. System 100 is a multi-media tool developed generally for service providers and, in some embodiments, specifically for the beauty-salon and personal-grooming industry. Fashion-file system 100 enables the service industry opportunities to reach their existing and future customers in a unique way that exemplifies value-added service. The system 100 includes one or more service stations 110 (e.g., having a chair 162, inputs such as touch-screen 181, keyboard 182, image acquisition 183, and/or voice recognition 184, and outputs such as visual display 185, printer 186, lighting 187, audio 188, temperature-control 189, chair-massage and/or foot massage 190, aroma-therapy generator 191, and/or PSD reader 192). Some embodiments include a digital camera 130, a server 140, and/or an intake kiosk 150.

Displaying an image includes outputting an image in a visually perceptible manner for viewing. In some embodiments, “displaying” an image includes, e.g., displaying an image on a CRT (cathode-ray tube), LCD (liquid crystal display), flat-panel display (e.g., plasma screen), holographic display, and/or printing an image by a printer (e.g., color inkjet or laser printer). “Dynamic displaying” of an image includes, e.g., displaying an image on a CRT (cathode-ray tube), LCD (liquid crystal display), flat-panel display (e.g., plasma screen), and/or holographic display.

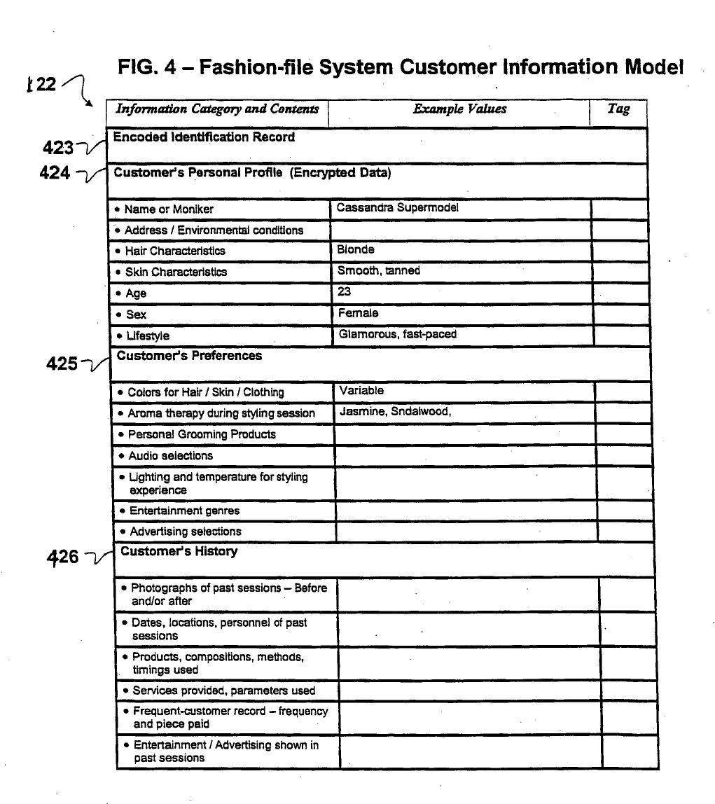

In some embodiments, system 100 is associated with a service site/business establishment (such as a beauty salon), and includes one or more service stations 110 (e.g., styling booths). In some embodiments, a customer-retained removable personal-storage device (PSD) 120 holds, maintains, and is updated with information about a customer (see FIG. 4 description below), and can be plugged or otherwise connected (e.g., using a connector 121, such as a universal serial bus (USB) plug) into the intake kiosk's slot 152 (such as a USB socket) to provide access to information and/or images stored on PSD 120. In some embodiments, PSD 120 includes a commonly available universal-serial-bus (USB) connected compact-flash memory currently available in sizes such as 64 MB, 128 MB, 256 MB, and 512 MB, which are ample to store a plurality of images and other information. In some embodiments, intake kiosk 150 includes input/output devices having, e.g., input mechanisms such as a keyboard 151, a plug-input slot 152, a touch-screen 153 which also serves as an output display, and/or voice recognition unit 154. In some embodiments, intake kiosk 150 is associated with and located at a reception desk at the business establishment. In other embodiments, each service station 110 includes an intake kiosk 150.

In some embodiments, service station 110 is associated with and located at a reception desk and/or podium at the business establishment. In other embodiments, each service provider (e.g. stylist) has a service station 110 at the service location (e.g., stylist booth).

In some embodiments, service station 110 is associated with and (at least partially) located at a reception desk and/or podium at the business establishment. For example, a reception desk optionally includes an intake kiosk slot 152 used to read an image (e.g., digital color photograph of the results of a prior session and printout a color copy of the image onto paper, which can be carried back to the styling chair 162.

In other embodiments, each service provider (e.g., stylist) has a service station 110 at the service location (e.g., stylist booth). For example, a PSD-reader 192 is used to retrieve a photo of a prior session from the customer's PSD 120 for display on display 181 at the styling chair 162.

In some embodiments, the fashion-file system 100 allows each customer to store a multitude of useful historical and preference information, such as images of the results of past services, that enable service employees (such as salon stylists) to better serve that customer and increase profitability for salons and salon-chain corporations. In some embodiments, this personal and historical customer information for each one of a plurality of customers is all stored on one or more centrally available storage servers 140 that are available over an internal network such as an Ethernet network or an intranet within a business establishment, or over a public network at least partially external to the business establishment, such as the internet. In some embodiments, useful information 122 includes personal profile 124 (e.g. name, address, age, hair and/or skin-quality characteristics, etc.), preferences 125 (e.g., colors for hair, aromas, entertainment genres, etc.), and/or history 126 (e.g., salon products used, and a photographic record of the customer's prior salon services, results, etc.). In some embodiments, useful information 122 is encrypted and stored on the storage device such as the removable PSD 120. In some embodiments, memory device 120 has enough memory and is capable of being updated with a lifetime of current useful information and is given back to the customer each time salon services are finished. In some embodiments, a reference database 141, within the storage server 140, holds other useful information such as news, advertising, and entertainment selection guides enabling the customers to view live or previously recorded entertainment and news networks including advertising or to play video games directly through the fashion-file display panel 185. In some embodiments, indicators of the products recommended to the customer, and the products purchased by the customer, are stored within the reference database. If the same hair and/or skin quality characteristics are entered from one visit to the next visit, the system will determine whether or not to recommend the same products based on if the products were actually purchased on the previous visit.

In some embodiments, each customer acquires or is provided a personal-storage device (PSD) 120, such as a USB-connectable FLASH memory key fob, into which is stored useful information 122 (e.g., customer's personal information, photographs of that customer's past haircuts, stylings, colorings, as well as data that records specific procedures, lengths, colors, compositions, tools, personnel used in past procedures, etc.). The PSD 120 is particularly useful for providing ease-of-mind to customers who might otherwise worry about loss of privacy were such information to be kept at the establishment. Further, in some embodiments, the data is encoded or encrypted with a password using well-known techniques and algorithms, such that if the PSD 120 is lost or stolen, the information stored thereon is not readily available to whoever later obtains the PSD 120. In some embodiments, the PSD 120 further includes an encoded identification record 123, such that if some good citizen finds the PSD 120 and returns or mails it to one of the participating salons, a central server there can use the encoded identification record to return the PSD 120 to its rightful owner.

In some embodiments, when a customer enters a business establishment that has a fashion-file system 100, the customer's information 122 is retrieved (from PSD 120 or central server 140), and is displayed on the intake kiosk's display 153, placed in the reception area. The personal-service technician or artist, and the customer, can together review the information and discuss the currently desired service as compared and contrasted to prior services. In some embodiments, each service station 110 may be equipped with an intake kiosk 150, allowing the customer and the stylist to discuss the customer's desired services in a more personal and private setting.

For example, the customer's information 122 could include photographs of various views of the results of the past three hair cuts and stylings, and the discussion could include changes, such as “I'd like this cut to be about 1 inch shorter than the cut I received two visits ago, but I don't want bangs anymore. I also want more blonde highlights, and I want all the roots carefully colored to the same color as they were three visits ago.”

The personal-service technician or artist could then specify parameters for the current hair styling, and, in some embodiments, system 100 then calculates the length of time that these services should take (e.g., 25 minutes) to complete, and so notifies the personal-service technician or artist of the allotted time. The service technician or artist could have the option to override the estimated length of time, to compensate for other factors. In some embodiments, system 100 determines the different products that could be used for the desired service, and allows the personal-service technician or artist to select the preferred products or to override the recommendations of system 100, and pick an entirely new set of products. System 100 also selects and retrieves 25 minutes of multimedia content (such as entertainment videos, news, advertisements, and interactive video games), providing the ability for the service technician, artist, or customer to override as desired.

Digital video recorders (such as TIVO®) allow recording of television programming for viewing at the time of personal choosing and could be used for customer entertainment during the time services are being performed. However, some amount of effort must be expended to control the playback to the user's preferences. In some embodiments, these customer preferences can be stored with customer information 122.

In some embodiments, system 100 can provide one or more of other ancillary services or ambiance chosen by the customer, such as audio, aroma therapy, and massage therapy. Of course, the customer may choose to decline any of these services and just relax in silence while the primary service is being rendered. In some embodiments, these customer preferences can be stored with customer information 122.

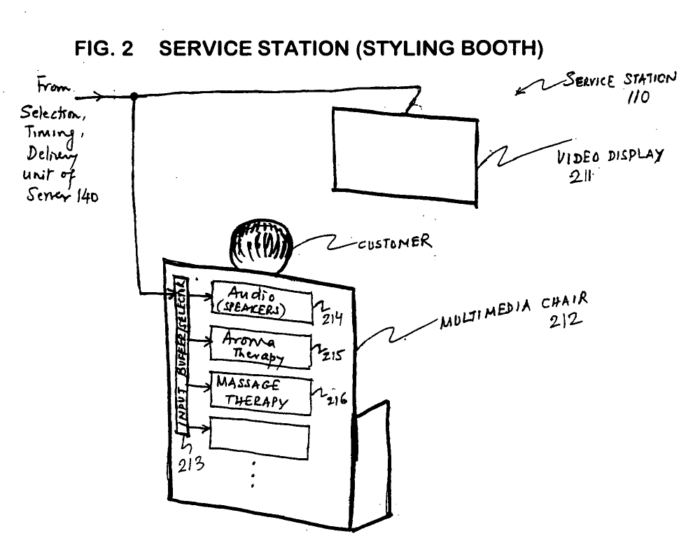

FIG. 2 shows a schematic representation of a service station or styling booth 110 of one embodiment of the present invention. Booth 110 includes a video display 211, a multimedia (MM) chair 212 equipped with an input buffer/selector 213 that channels outputs to an audio unit 214, an aroma therapy unit 215, a massage-therapy unit 216, and so on. In some embodiments, the video display 211 will show, for the duration of the service, the multimedia content (such as entertainment videos, news, advertisements, and interactive video games) pre-selected by the customer, and retrieved from the storage server 140. Video programs may include live broadcast of TV programs such as sitcoms, soap operas, reality shows, sport events and other special-interest programs. Customers may alternately choose to view pre-recorded material such as movies on video tapes and/or DVDs. In some embodiments, digital video recorders (such as TIVO®) may be employed to provide a Broadcast record and replay function, e.g., record CNN's or Fox's top-of-the-hour headlines when broadcast, then play (optionally with the original ads) at a predetermined point in the scheduled and timed MM display for the customer. Further, in some embodiments, the customer may want to bypass the system 100 selections and provide his or her own content in a free-standing form such as a video tape or a DVD.

In some embodiments, system 100 can provide one or more of other ancillary services chosen by the customer, such as audio, aroma therapy, and massage therapy. For example, if the customer wants a gentle massage during a hair styling session, system 100 retrieves the appropriate selection from the storage server 140, and pipes it to the massage therapy unit 216, via the input buffer/selector 213. In some embodiments, the multimedia chair 212 also includes or is used as a massage chair (such as Interactive Health® HTT-10(10i)-CRP Massage Lounger) with the massage therapy unit 216 acting as an automated controller of the massage lounger, i.e., interfaced to control the function and timing of the massage, with an optional manual override operated by the customer and/or the stylist, and timed for the duration of the service. In some embodiments, the massage chair 212 is an automated mechanism emulating human hands to provide several massage functions such as rolling, kneading, compression, and percussion in multiple speeds. Alternately, the customer may choose to select one of several fixed-duration (say 15 minutes) pre-programmed massage sessions with the touch of a button on the manual control 216. In some embodiments, the massage chair 212 is equipped with an ergonomically-designed headrest, and a range control to customize the location of the various massage functions such as kneading and compression. In some embodiments, the massage chair 212 has a built-in footrest to provide a programmable and multi-speed massage for customer's calves and feet. In some embodiments, the customer's PSD 120 has stored into it the choices, types, and the customer's ratings of massages provided by massage therapy unit 216 such that the customer, during future visits to the establishment, can look up those settings that she or he most enjoyed, and have those settings automatically used without having to remember or re-enter those settings.

In some other embodiments, the foot massage may be provided by a free-standing foot massager (such as Interactive Healthg WA-200 WarmAir® Percussive Foot Massager). Upon the customer's request, the foot massager can be prepped and turned on by the stylist, or automatically controlled by massage therapy unit 216. Prepping may require setting the temperature of the water (e.g., to high, medium or low), setting the timer to match the duration of the service, adding salts, soaps, and/or muscle-relaxant chemicals to the water, setting the massage type and intensity, and so forth. In some embodiments, the customer's PSD 120 has stored into it the choices, types, and the customer's ratings of foot massages provided by massage therapy unit 216 such that the customer, during future visits to the establishment, can look up those settings that she or he most enjoyed, and have those settings automatically used without having to remember or re-enter those settings.

In some embodiments, the customer may choose to have just audio 214 piped in through the input buffer/selector 213 to a set of speakers embedded in the multimedia chair 212 in the general vicinity of the customer's hearing area. The audio could be sourced from one of the local radio stations or from a CD/tape player belonging to the service site/business establishment. In some embodiments, the customer may want to bypass the system 100 selections and provide his or her own audio content in a free-standing form such as audio cassettes, CDs, or MP3s. In some embodiments, the audio content selection and/or timing is determined and automatically controlled and delivered by system 100, at least in part, based on the anticipated duration or timing of the service to be provided, and/or the personal preferences stored in the customer's PSD 120. In some embodiments, the customer's PSD 120 has stored into it the choices, types, and the customer's audio settings provided in this session such that the customer, during future visits to the establishment, can look up those settings that she or he most enjoyed, and have those settings automatically used without having to remember or re-enter those settings.

In some embodiments, the customer may choose to indulge in some aroma therapy, and have its instructions piped in to the aroma therapy unit 215, via the input buffer/selector 213, both housed as part of the multimedia chair 212. In some embodiments, the aroma therapy unit 215 comprises a plurality of aroma sources, each having a venture spray atomizer, heater (e.g., adapted from a bubble-jet) and/or droplet generator (such as taking a multi-color ink-jet printer head (e.g., from a Canon S900 printer), but with the ink supplies replaced with aromatic products, such as cinnamon oil, vanilla extract, lily-of-the-valley extract, and/or other perfumes or aroma sources). In some embodiments, the aroma therapy unit 215 can be manually controlled by the customer and/or the stylist, and timed for the duration of the service. In some embodiments, the aroma therapy content selection and/or timing is determined and automatically controlled and delivered by system 100, based, at least in part, by the anticipated duration or timing of the service to be provided, and/or the personal preferences stored in the customer's PSD 120. In some embodiments, the customer's PSD 120 has stored into it the choices, types, and the customer's settings of aroma therapy provided in this session such that the customer, during future visits to the establishment, can look up those settings that she or he most enjoyed, and have those settings automatically used without having to remember or re-enter those settings.

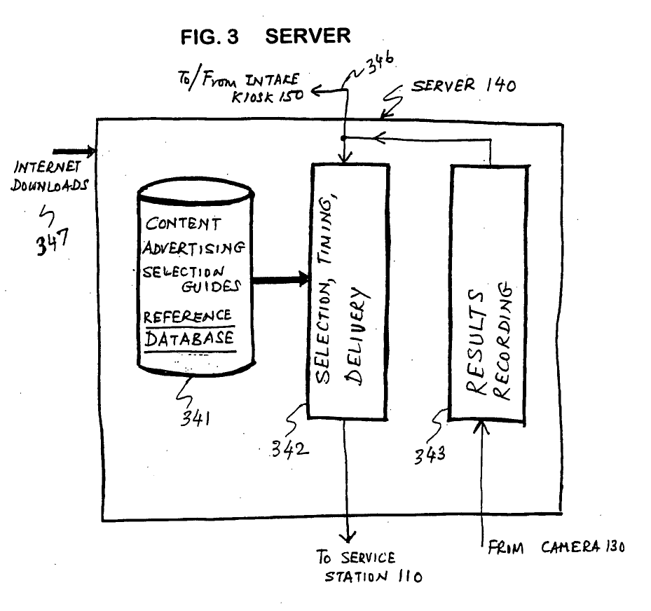

FIG. 3 shows a schematic representation of a server 140 of one embodiment of the present invention. Server 140 includes a reference database 341 that holds information such as advertising, and selection guides, a selection/timing/delivery module 342 that provides to each service station 110 appropriate information from the database 341, based on inputs received from the intake kiosk 150 through a channel 346, and a results recording module 343 that stores information about services rendered (e.g., photographs taken by digital camera 130), and pipes it to the PSD 120 via the intake kiosk 150 through channel 346.

In some embodiments, the server 140 can also receive internet downloads 347 that are then stored in the reference database 341.

In some embodiments, the selection/timing/delivery module 342 upon receiving the customer information and preferences input from the intake kiosk 150 through a channel 346, will retrieve the appropriate content from the reference database 341, and pipe that content along with other customer information to the service station (or styling booth) 110.

In some embodiments, the results of the service rendered, such as photographs of the finished hair styling, or the products and methods used, are received from the service station 110 by the results recording unit 343, which then transfers it to the intake kiosk 150 via channel 346 for ultimate storage and update to the customer information 122 in the PSD 120. In some embodiments, the results may also be stored in the customer record in the reference database 341.

In some embodiments, the server may be located at one service site but shared among other remote sites, available to those sites over an internal network such as an Ethernet network or an intranet within a business establishment, or over a public network at least partially external to the business establishment, such as the internet. In some embodiments, the server may be located at a centralized data center and shared among various service sites located remotely from the data center.

FIG. 4 shows a schematic representation of a customer information model 122 of one embodiment of the present invention. Information model 122 specifies an encoded identification record 423, a customer's personal profile 424 (including information such as customer's name, age, sex, etc.), customer's preferences 425 (including information such as customer's preferences for hair color, aroma therapy, video programming, etc.), and customer's history 426 (including information such as photographs of past services rendered to customer, products used, entertainment shown, etc.)

In some embodiments, one determination made at the beauty salon is the expected length of time for the service. This is used, with the customer preferences as currently entered or downloaded from the customer's USB FLASH memory (e.g., PSD 120), to select pieces of the multimedia (MM) presentation such that the presentation time matches the time of the hair styling or at least the portion of the time of the hair styling that is available for the customer to view the MM presentation (i.e., a 45-minute styling that includes 7 minutes for a shampoo and conditioning leaves 38 minutes for the MM presentation, and the selector chooses 38 minutes of programming for that customer). The selection of MM content is also based on the customer's preferences and/or the history of past presentations.

In some embodiments, a kiosk is placed in a retail location such as a beauty store or personal-hygiene department. The customer inserts their PSD 120 and enters the general product desired, such as facial cream or hair conditioner. In some embodiments, the customer inserts their PSD 120 (which contains the indication of the prior skin and hair-quality parameters), and provides or enters updated information as to these characteristics, and the updated information is stored back onto the PSD 120. The system cross references with current skin and hair-quality parameters and recommends specific products based on customer data and current store inventory, with directions for finding or locating the items.

In some embodiments, the invention is applied to other service industries, e.g., airline in-flight entertainment, airport waiting-area entertainment, bus-terminal waiting-area entertainment, doctor's office waiting rooms and examination rooms, automobile-maintenance and repair-shop waiting-area entertainment, and/or restaurants.

In some embodiments, an in-flight airline passenger would enter/connect their personalized selection USB memory to an input device, and an expected flight time (e.g., 145 minutes per the standard schedule) would be adjusted in the airplane's computer for today's conditions (e.g., weather and winds relative to an average flight, “fly-arounds”, etc.) and other adjustments such as today's dinner delivery, giving a presentation time. Scenes from a movie and advertising could be selected to fill the presentation time. For the presentation time available, different scenes could be cut from the movie, or different filler or advertising material added. Different people on the same flight could get different selections based on their viewing history and/or preferences.

In some embodiments, an airline passenger who is in-between flights with a rather substantial layover would enter/connect their personalized selection USB memory to an input device, housed in a private kiosk in the general waiting area of the airport or in executive lounges offered by the airlines, along with the expected waiting time. In some embodiments, the wait time could be automatically computed by the system, based on the flight boarding time, time to get to the departure gate from the system's current location, and any other delays that the passenger might expect, such as stops for snacks, shopping or bathroom. Based on the time available, scenes from a 2.5 hour movie and enough advertising would be selected (a predetermined formula would take the original 150 minutes, and determine that if 18 minutes are to be cut, it's these 5 scenes that can be cut, and these 3 ads inserted and still have the movie make sense). For other times and different movies, different scenes could be cut, or different filler material added. Different people waiting for the same flight get different selections based on their viewing history and/or preferences.

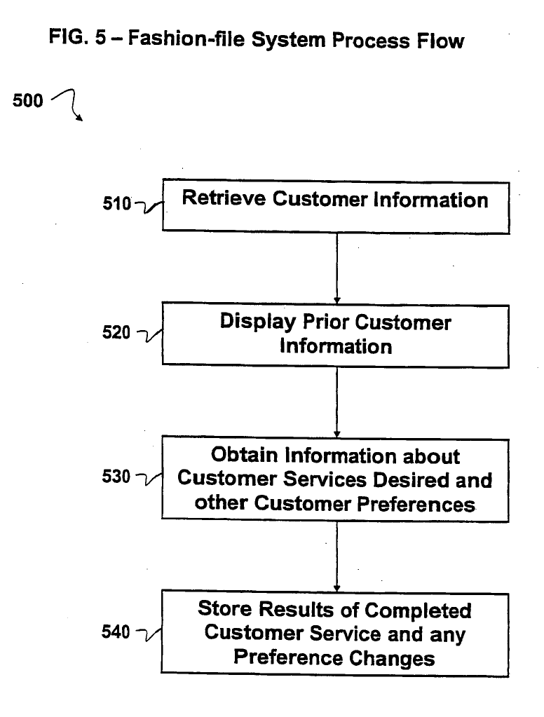

FIG. 5 is a flowchart of a method 500 used in some embodiments of the invention. At block 510, system 100 retrieves the customer information (e.g., from PSD 120 or other location). At block 520, system 100 displays the customer's prior information and/or history (e.g., a digital image of the results of a prior visit). At block 530, system 100 obtains further information (e.g., from the customer inputting to a keyboard or voice-recognition system) regarding the services the customer desires, changes relative to the prior photograph, preferences relative to music or other entertainment choices, etc. At block 540 (typically after completion of the services for today's visit), system 100 stores results of the completed customer service and/or any preference changes (e.g., a photograph of the resulting hair styling or other services, and the fact that certain entertainment was presented such that it is not unduly repeated in later sessions). Further details, as used in some embodiments, of the functions of each of these blocks and other blocks are described above and below.

Automated Sales Person

In some embodiments, as salon service(s) begin, the customer inserts their removable memory device (e.g., PSD 120) into the fashion-file system 110 and enters their current hair and or skin quality characteristics directly on the flat panel touch-screen input/display device of I/O system 150. The fashion-file database 141 takes into consideration such data as current hair and/or skin quality characteristics, time of year, where you live, weather trends (including pollution), the customer's age and then recommends products from the salon's inventory directly on the flat-panel touch-screen input and display device 153. This automated salesperson feature allows the salon owner/manager to be assured that the absolute best products are being recommended to each unique customer. As customers see the product displayed directly in front of them on screen and realize the product is specifically tailored to their needs, the decision the customer needs to make is an easy one. In the modern era we all live in, customers want to make their decisions based on credible information. Customers now have many choices and locations to purchase what used to be only salon quality product. If credible and useful information as to why the customer should buy from the salon at the time of the service is not available, trends show the customer will simply look for product elsewhere at a more “reasonable” cost. The fashion-file system 100 is a modern-day salon tool providing vastly more credible opportunities to sell product specifically tailored to each customer's needs.

Photographic Record

The fashion-file system 100 is a tool for the customer and stylist. In some embodiments, after each and every salon service the customer has an opportunity to store a visual representation of the services they acquired. Once the salon service is finished, digital photographs are taken with a digital camera 130 connected to the fashion-file system 100. These photographs are then written only to the customer's removable personal-storage device (PSD) 120, which is capable of storing a lifetime of digital photographs and customer characteristics.

Thus, the fashion-file system 100 is a tool and a visual means to enable greater opportunities in achieving the customers' desired results. In some embodiments, by simply inserting the customers' removable personal storage device (PSD) 120 and after their current hair and/or skin quality characteristics are entered, all historical photographic records are accessed and displayed on the flat panel touch-screen input/display device 153. These photographic records on the removable PSD 120 are useful because of the desirable characteristics listed in Table 1.

TABLE 1
A picture truly can say a thousand words;
Customer loyalty is increased knowing they can access their historical
information on their removable memory device only at the salon or
network (chain) of salons that are franchised to issue it;
If a network (chain or franchise) salon issued the memory device, then the
customer can go to any salon worldwide (within that franchise or corporate
control) to access their historical information;
If a network (chain) salon issued the memory device the customer is not
hesitant to acquire services away on travel for business or vacation when
normally reserved for just before or after returning;
In a network (chain) away from home the customer is at ease knowing
there is a very good opportunity for a high quality service just as though
they had been going to the very same salon forever;
They are a reference point for the future;
They track patterns such as thinning hair, etc;
Very strong possibilities that the photographic records in combination or
by themselves represent the exact style or shape or cut or color or length
of the service currently wanted by the customer;
The salon can save time which offers more available appointments in a
day;
Saves the customer valuable time; and
The removable memory device is small enough to be added to the
customer keychain acting as a constant reminder that they approved and
purchased quality services. By the customer retaining the memory device,
it develops a sense of ownership and control over their appearance. The
customer control and ownership will benefit the salon or salon chain as the
customer will desire to professionally maintain or alter their appearance
more frequently.

Entertainment, News and Advertising:

In conjunction with customers viewing historical data stored on their removable personal storage device (PSD) 120, they are also able to view live or previously recorded entertainment and news networks including advertising directly through the fashion-file system 100's video display panel 211. In some embodiments, if no customer preferences are selected for this feature, then the remote server 140 evaluates the customer's age, region of world/country/state/city and displays the currently available media specific for that customer type. Viewable media may include: New York Stock Exchange, Sports Networks, CNN, Fox News, Daytime T.V., Non-Stop Salon Product Advertisements, Fashion T.V., Food Network, HGTV, etc. In some embodiments, a delayed-viewing function such as available from TIVO®-like digital disk video recorders is used to synchronize the start time and length of presentation from such recorded multimedia broadcast sources.

In some embodiments, some or all of the following functions of Tables 2, 3, and 4 are performed for a method of the present invention:

TABLE 2
For a first-time user of system 100, some embodiments of
the method include at least some of the following:

| | |
|---|---|
| 1. | Customer memory device (PSD 120) is purchased at the salon and |
| | inserted into the fashion-file system 100's intake kiosk 150. |
| 2. | Hair quality and skin characteristic options are displayed on the input/ |
| | output touch screen 153 in “check box” format and a selection made |
| | by the customer. |
| 3. | Stylist and customer discuss current hair quality and skin |
| | characteristic. At this time the stylist enters appropriate options via |
| | touchscreen device 153. |
| 4. | Currently used hair and skin product options are displayed on screen |
| | 153 |
| | in checkbox format and selected via touch screen device 153. |
| 5. | Entertainment options are displayed on screen 153 in “check box” |
| | format and selected via touch screen device 153. |
| 6. | The above information gets transmitted to the local server via |
| | wireless transmission then in-turn to the remote server. |
| 7. | The salon services begin. |
| 8. | During the salon services, the remote server downloads and displays |
| | product recommendations and entertainment media based on unique |
| | customer preferences (selected above) for viewing on screen. |
| 9. | The salon services are finished. |
| 10. | Up to 4 (or more) digital pictures of the approved customer haircut / |
| | styling or cosmetology service are taken by the stylist. |
| 11. | If product is desired for purchasing by the client, the current product |
| | usage options are updated at this time. |
| 12. | The customer memory device gets updated with current hair and skin |
| | characteristics, products currently in use and digital photographs.. |
| 13. | The customer memory device is removed from the fashion-file for |
| | safe keeping by the customer or salon. |

TABLE 3
For successive salon visits, some embodiments
include at least some of the following:

| | |
|---|---|
| 14. | Customer memory device (PSD) 120 is inserted into the fashion-file |
| | system 100's intake kiosk 150. |
| 15. | Prior hair and skin characteristics are displayed on the input/output |
| | touch screen 153 in “check box” format. |
| 16. | Current hair and skin characteristics are discussed and compared to |
| | previous entry and updated on the input/output touch screen 153 as |
| | needed. |
| 17. | Prior hair and skin product usage options are displayed on the input/ |
| | output touch screen 153 in “check box” format. |
| 18. | Current hair and skin product usage is updated on the input/output |
| | touch screen 153 as needed. |
| 19. | Prior entertainment options are displayed on the input/output touch |
| | screen 153 in “check box” format. |
| 20. | Current entertainment options are updated as needed for this salon |
| | visit. |
| 21. | The above information gets transmitted to the local server via |
| | wireless transmission then in-turn to the remote server 140. |
| 22. | In some embodiments, ONLY NOW do all the customers' past |
| | haircuts / styling and cosmetology pictures stored on the inserted |
| | memory device 120 become available for viewing on the input/output |
| | touch screen 153. |
| 23. | While the photographs are displayed on the input/output touch |
| | screen 153 the customer and salon employee discuss past haircuts / |
| | styling and or cosmetology services. |
| 24. | The salon services begin. |
| 25. | During the salon services, the remote server 140 downloads and |
| | displays product recommendations and entertainment media based on |
| | unique customer preferences (selected above) for viewing on the |
| | video display screen 211. |
| 26. | The salon services are finished. |
| 27. | Up to 4 digital pictures of the approved customer haircut / styling |
| | or cosmology service is taken by the stylist. |
| 28. | If product is desired for purchasing by the client, the current |
| | product usage options are updated at this time. |
| 29. | The customer memory device 120 gets updated with current hair |
| | and skin characteristics, products currently in use and digital |
| | photographs. |
| 30. | The customer memory device 120 is removed from the fashion-file |
| | intake kiosk 150 for safe keeping by the customer or salon. |

TABLE 4
In some embodiments, a stored Data Structure includes
some or all of the following Hair-Quality Characteristics:

Medium to fine
Fine to thin
Dry, coarse, wiry
Fine, fragile
Dry, brittle, damaged
Structurally damaged
Natural curl, permed, wiry
Build up of hard water, medication, chlorine
Dandruff, oily scalp, psoriasis
Natural curl, coarse, excessive curl
Fine soft styles
Medium, coarse, hard to hold styles
Thermal styling
Fine, soft, straight styles
Medium to coarse, hard to hold styles
Penned, color-treated, permanently relaxed
Etc.
In some embodiments, a similar list of skin characteristics is stored.

Aspects of Some Embodiments of the Invention

In some embodiments, the invention provides a computerized method that includes receiving data from a first storage device indicative of past personal service and including a digital photographic image pertaining to a past service delivery to a particular first user, displaying at a first station the image for the first user and a first service provider, receiving input as to a first present service desired by the first user, and after performance of the first present service, storing a digital photographic image pertaining to the first present service to the first storage device.

Some embodiments of the method further include selecting and presenting, at the first station, first multimedia content in a sequence based on a timing and performance of the first personal service delivery.

In some embodiments, the first storage device is a personal storage device suitably small to be taken and easily carried by the first user in a shirt pocket.

Some embodiments of the method further include receiving data from a second storage device indicative of past personal service and of a digital photographic image pertaining to a past service delivery to a particular second user, displaying at a second station the image for the second user and a second service provider, receiving input as to a second present service desired by the second user, and after performance of the second present service, storing a digital photographic image pertaining to the second present service to the second storage device.

Some embodiments of the method further include selecting and presenting, at the second station, second multimedia content in a sequence based on a timing and performance of the second personal service delivery, downloading the first content from a server to the first station, and downloading the second content from the server to the second station.

In some embodiments, the second storage device is a personal storage device suitably small to be taken and easily carried by the second user in a shirt pocket.

In some embodiments, the second storage device and the first storage device are the same device and are available in concurrently to a plurality of geographically separated stations.

In some embodiments, a selection of the first content is based on indicated preferences of the first user, and a selection of the second content is different than the first and is based on indicated preferences of the second user.

In some embodiments, the invention provides a computerized method that includes receiving data from a storage device indicative of past personal service and including a digital photographic image pertaining to a past service delivery to a particular first user, displaying at a first station the image for the first user and a first service provider, receiving input as to a first present service desired by the first user, and selecting and presenting, at the first station, first multimedia content in a sequence based on timing and performance of the first personal service delivery.

Some embodiments of the method further include receiving data from a storage device indicative of past personal service and of a digital photographic image pertaining to a past service delivery to a particular second user, displaying at a first station the image for the second user and a second service provider, receiving input as to a second present service desired by the second user, presenting, at the second station, second multimedia content in a sequence based on timing and performance of the second personal service delivery.

In some embodiments of the method, a selection of the first content is based on indicated preferences of the first user.

In some embodiments of the method, the input as to the first present service desired by the first user includes an indication of changes relative to the past service delivery.

In some embodiments of the method, the service includes a hair-styling service, the image is of a previous hair styling, and the data indicative of past personal service includes information indicative of one or more details of the previous hair styling.

In some embodiments of the method, the service includes a food-preparation service, the image is of a previous meal, and the data indicative of past personal service includes information indicative of one or more details of the previous food preparation.

Some embodiments of the method further include receiving data from the storage device indicative of personal preferences of the first user, and wherein selection of which content to be presented is based on the received data indicative of the personal preferences.

In some embodiments of the method, the service includes a hair-styling service, the image is of a previous hair styling, and the data indicative of past personal service includes information indicative of an amount of time taken to perform the previous hair styling, and wherein selection of content and timing of content presentation is based on the received data indicative of the previous amount of time taken.

In some embodiments of the method, the service includes a hair-styling service, the image is of a previous hair styling, and the data input received as to the present service desired by the first user includes data specifying a type of content to be presented.

In some embodiments of the method, the service includes a hair-styling service, the image is of a previous hair styling, and the data input received as to the present service desired by the first user includes data selecting a specific content to be presented.

In some embodiments of the method, the service includes a hair-styling service, the image is of a previous hair styling, and the presentation of content includes an audio and visual presentation of both entertainment and advertising based on data received as to the present service desired.

Another aspect of some embodiments provides a system that includes a computer configured to receive data from a storage device indicative of past personal service and including a digital photographic image pertaining to a past service delivery to a particular first user, a first display at a first station operatively coupled to the computer to display the image for the first user and a first service provider, a first input device operatively coupled to the computer to receive input as to a first present service desired by the first user, and a content selector in the computer configured to present on the first display, first multimedia content in a sequence based on timing and performance of the first personal service delivery.

In some embodiments of the system, the computer is further configured to receive data indicative of past personal service and including a digital photographic image pertaining to a past service delivery to a particular second user, and wherein the system further includes a second display at a second station operatively coupled to the computer to display the image for the second user and a second service provider, and a second input device operatively coupled to the computer to receive input as to a second present service desired by the second user, and wherein the content selector is also configured to present on the second display, second multimedia content in a sequence based on timing and performance of the second personal service delivery.

In some embodiments of the system, the content selector makes selection of the first content based on indicated preferences of the first user.

In some embodiments of the system, the input as to the first present service desired by the first user includes an indication of changes for the first present service relative to the past service delivery.

In some embodiments of the system, the service includes a hair-styling service, the image is of a previous hair styling, and the data indicative of past personal service includes information indicative of one or more details of the previous hair styling.

In some embodiments of the system, the service includes a food-preparation service, the image is of a previous meal, and the data indicative of past personal service includes information indicative of one or more details of the previous food preparation.

In some embodiments of the system, the computer is configured to receive data from the first storage device indicative of personal preferences of the first user, and wherein selection of which content to be presented is based on the received data indicative of the personal preferences.

In some embodiments of the system, the service includes a hair-styling service, the image is of a previous hair styling, and the data indicative of past personal service includes information indicative of an amount of time taken to perform the previous hair styling, and wherein selection of content and timing of content presentation is based on the received data indicative of the previous amount of time taken.

In some embodiments of the system, the service includes a hair-styling service, the image is of a previous hair styling, and the data input received as to the present service desired by the first user includes data specifying a type of content to be presented.

In some embodiments of the system, the service includes a hair-styling service, the image is of a previous hair styling, and the data input received as to the present service desired by the first user includes data that selects a specific content to be presented.

In some embodiments of the system, the service includes a hair-styling service, the image is of a previous hair styling, and the presentation of content includes an audio and visual presentation of both entertainment and advertising based on data received as to the present service desired.

In some embodiments of the system, the first and second storage devices are both part of a single centralized storage server.

In some embodiments of the system, the first and second storage devices are separate removable storage devices kept by the first and second user, respectively.

Another aspect of some embodiments provides a system that includes a computer configured to receive data, from a first removable personal-storage device, indicative of past hair-styling service and including a digital photographic image of a past hair-styling result for a particular first user, a first display at a first station operatively coupled to the computer to display the hair-styling image for the first user and a first service provider, a first input device operatively coupled to the computer to receive input as to a first present hair-styling service desired, and as to entertainment preferences of, the first user, and a content selector in the computer configured to present on the first display, first multimedia content in a sequence based at least in part on anticipated timing and performance of the first hair-styling service delivery and the entertainment preferences of the first user.

In some embodiments of the system, the computer is further configured to receive data from a second removable personal-storage device, the data indicative of past personal service and including a digital photographic image pertaining to a past service delivery to a particular second user, and wherein the system further includes a second display at a second station operatively coupled to the computer to display the hair-styling image for the second user and a second service provider, and a second input device operatively coupled to the computer to receive input as to a second present hair-styling service desired by the second user, and wherein the content selector is also configured to present on the second display, second multimedia content in a sequence based on timing and performance of the second hair-styling service delivery and the entertainment preferences of the second user.

In some embodiments of the system, the input as to the first present service desired by the first user includes an indication of changes for the first present service relative to the past service delivery.

In some embodiments of the system, the computer is configured to receive data from the first personal-storage device indicative of personal preferences of the first user, and wherein selection of which content to be presented is based on the received data indicative of the personal preferences.

Another aspect of some embodiments provides a system that includes a computer, a first display operatively coupled to the computer, means, operatively coupled to the computer, for receiving data from a storage device indicative of past personal service and including a digital photographic image pertaining to a past service delivery to a particular first user, and for receiving input as to a present service desired by the first user, means for displaying on the first display the image for the first user and a first service provider, and means for selecting and presenting, at the first display, first multimedia content in a sequence based on timing and performance of the personal service delivery to the first user.

Some embodiments further include a second display operatively coupled to the computer, means, operatively coupled to the computer, for receiving data indicative of past personal service and including a digital photographic image pertaining to a past service delivery to a particular second user, and for receiving input as to a present service desired by the second user, means for displaying on the second display the image for the second user and a second service provider, and means for selecting and presenting, at the second display, second multimedia content in a sequence based on timing and performance of the personal service delivery to the second user.

Some embodiments further include means for indicating desired changes for the present service to the first user relative to the past service delivery.

Some embodiments further include means for receiving data indicative of personal preferences of the first user, and wherein the means for selecting and presenting content to be presented makes selections based on the received data indicative of the personal preferences.

Another aspect of some embodiments provides a computer-readable data structure that includes a digital photograph of a hair-styling result, data indicative of one or more hair-quality characteristics, and data indicative of entertainment preferences.

Some embodiments further include data indicative of one or more skin-quality characteristics, and data indicative of personal-grooming-product references.

Another aspect of some embodiments provides a computer-readable medium having instructions stored thereon for causing a suitably-programmed information-processing system to perform a method that includes receiving data from a storage device indicative of past personal service and including a digital photographic image pertaining to a past service delivery to a particular first user, displaying at a first station the image for the first user and a first service provider, receiving input as to a first present service desired by the first user, and selecting and presenting, at the first station, first multimedia content in a sequence based on timing and performance of the first personal service delivery.

Some embodiments further include instructions stored thereon such that the method further includes receiving data from a storage device indicative of past personal service and of a digital photographic image pertaining to a past service delivery to a particular second user, displaying at a first station the image for the second user and a second service provider, receiving input as to a second present service desired by the second user, selecting and presenting, at the second station, second multimedia content in a sequence based on timing and performance of the second personal service delivery.

Some embodiments further include instructions stored thereon such that the method further includes selecting the first content based on indicated preferences of the first user.

Some embodiments further include instructions stored thereon such that the method further includes receiving and displaying an indication of changes relative to the past service delivery.

It is understood that the above description is intended to be illustrative, and not restrictive. Although numerous characteristics and advantages of various embodiments as described herein have been set forth in the foregoing description, together with details of the structure and function of various embodiments, many other embodiments and changes to details will be apparent to those of skill in the art upon reviewing the above description. The scope of the invention should be, therefore, determined with reference to the appended claims, along with the full scope of equivalents to which such claims are entitled. In the appended claims, the terms “including” and “in which” are used as the plain-English equivalents of the respective terms “comprising” and “wherein,” respectively. Moreover, the terms “first,” “second,” and “third,” etc., are used merely as labels, and are not intended to impose numerical requirements on their objects.

What is claimed is:

1. A computerized method comprising:
receiving data from a first storage device indicative of past personal service and including a digital photographic image pertaining to a past service delivery to a particular first user;
displaying at a first station the image for the first user and a first service provider;
receiving input as to a first present service desired by the first user; and
after performance of the first present service, storing a digital photographic image pertaining to the first present service to the first storage device.

2. The method of claim 1, further comprising:
selecting and presenting, at the first station, first multimedia content in a sequence based on a timing and performance of the first personal service delivery.

3. The method of claim 1, wherein the first storage device is a personal storage device suitably small to be taken and easily carried by the first user in a shirt pocket.

4. The method of claim 1, further comprising:
receiving data from a second storage device indicative of past personal service and of a digital photographic image pertaining to a past service delivery to a particular second user;
displaying at a second station the image for the second user and a second service provider;
receiving input as to a second present service desired by the second user; and
after performance of the second present service, storing a digital photographic image pertaining to the second present service to the second storage device.

5. The method of claim 4, further comprising:
selecting and presenting, at the second station, second multimedia content in a sequence based on a timing and performance of the second personal service delivery;
downloading the first content from a server to the first station; and
downloading the second content from the server to the second station.

6. The method of claim 4, wherein the second storage device is a personal storage device suitably small to be taken and easily carried by the second user in a shirt pocket.

7. The method of claim 4, wherein the second storage device and the first storage device are the same device and are available in concurrently to a plurality of geographically separated stations.

8. The method of claim 4, wherein a selection of the first content is based on indicated preferences of the first user, and a selection of the second content is different than the first and is based on indicated preferences of the second user.

9. The method of claim 8, wherein the service includes a hair-styling service, the image is of a previous hair styling, and the data indicative of past personal service includes information indicative of one or more details of the previous hair styling.

10. The method of claim 8, wherein the service includes a hair-styling service, the image is of a previous hair styling, and the data indicative of past personal service includes information indicative of an amount of time taken to perform the previous hair styling, and wherein selection of content and timing of content presentation is based on the received data indicative of the previous amount of time taken.

11. The method of claim 4, wherein the service includes a hair-styling service, the image is of a previous hair styling, and the data input received as to the present service desired by the first user includes data specifying a type of content to be presented.

12. The method of claim 4, wherein the service includes a hair-styling service, the image is of a previous hair styling, and the data input received as to the present service desired by the first user includes data selecting a specific content to be presented.

13. The method of claim 4, wherein the service includes a hair-styling service, the image is of a previous hair styling, and the presentation of content includes an audio and visual presentation of both entertainment and advertising based on data received as to the present service desired.

14. The method of claim 1, wherein the input as to the first present service desired by the first user includes an indication of changes relative to the past service delivery.

15. The method of claim 1, wherein the service includes a food-preparation service, the image is of a previous meal, and the data indicative of past personal service includes information indicative of one or more details of the previous food preparation.

16. The method of claim 1, further comprising:
receiving data from the storage device indicative of personal preferences of the first user, and wherein selection of which content to be presented is based on the received data indicative of the personal preferences.

17. A system comprising:
a computer configured to receive data from a storage device indicative of past personal service and including a digital photographic image pertaining to a past service delivery to a particular first user;
a first display at a first station operatively coupled to the computer to display the image for the first user and a first service provider;
a first input device operatively coupled to the computer to receive input as to a first present service desired by the first user; and
a content selector in the computer configured to present on the first display, first multimedia content in a sequence based on timing and performance of the first personal service delivery.

18. The system of claim 17, wherein the computer is further configured to receive data indicative of past personal service and including a digital photographic image pertaining to a past service delivery to a particular second user; and wherein the system further includes:
a second display at a second station operatively coupled to the computer to display the image for the second user and a second service provider; and
a second input device operatively coupled to the computer to receive input as to a second present service desired by the second user, and wherein the content selector is also configured to present on the second display, second multimedia content in a sequence based on timing and performance of the second personal service delivery.

19. The system of claim 18, wherein the content selector makes selection of the first content based on indicated preferences of the first user.

20. The system of claim 19, wherein the service includes a hair-styling service, the image is of a previous hair styling, and the data indicative of past personal service includes information indicative of one or more details of the previous hair styling.

21. The system of claim 17, wherein the input as to the first present service desired by the first user includes an indication of changes for the first present service relative to the past service delivery.

22. The system of claim 17, wherein the service includes a food-preparation service, the image is of a previous meal, and the data indicative of past personal service includes information indicative of one or more details of the previous food preparation.

23. The system of claim 17, wherein the computer is configured to receive data from the first storage device indicative of personal preferences of the first user, and wherein selection of which content to be presented is based on the received data indicative of the personal preferences.

24. The system of claim 19, wherein the service includes a hair-styling service, the image is of a previous hair styling, and the data indicative of past personal service includes information indicative of an amount of time taken to perform the previous hair styling, and wherein selection of content and timing of content presentation is based on the received data indicative of the previous amount of time taken.

25. The system of claim 18, wherein the service includes a hair-styling service, the image is of a previous hair styling, and the data input received as to the present service desired by the first user includes data specifying a type of content to be presented.

26. The system of claim 18, wherein the service includes a hair-styling service, the image is of a previous hair styling, and the data input received as to the present service desired by the first user includes data that selects a specific content to be presented.

27. The system of claim 18, wherein the service includes a hair-styling service, the image is of a previous hair styling, and the presentation of content includes an audio and visual presentation of both entertainment and advertising based on data received as to the present service desired.

28. The system of claim 18, wherein the first and second storage device are both part of a single centralized storage server.

29. The system of claim 18, wherein the first and second storage device are separate removable storage devices kept by the first and second user, respectively.

30. A system comprising:
a computer configured to receive data, from a first removable personal-storage device, indicative of past hair-styling service and including a digital photographic image of a past hair-styling result for a particular first user;
a first display at a first station operatively coupled to the computer to display the hair-styling image for the first user and a first service provider;
a first input device operatively coupled to the computer to receive input as to a first present hair-styling service desired, and as to entertainment preferences of, the first user; and
a content selector in the computer configured to present on the first display, first multimedia content in a sequence based at least in part on anticipated timing and performance of the first hair-styling service delivery and the entertainment preferences of the first user.

31. The system of claim 30, wherein the computer is further configured to receive data from a second removable personal-storage device, the data indicative of past personal service and including a digital photographic image pertaining to a past service delivery to a particular second user, and wherein the system further includes:
a second display at a second station operatively coupled to the computer to display the hair-styling image for the second user and a second service provider; and
a second input device operatively coupled to the computer to receive input as to a second present hair-styling service desired by the second user, and wherein the content selector is also configured to present on the second display, second multimedia content in a sequence based on timing and performance of the second hair-styling service delivery and the entertainment preferences of the second user.

32. The system of claim 31, wherein the input as to the first present service desired by the first user includes an indication of changes for the first present service relative to the past service delivery.

33. The system of claim 31, wherein the computer is configured to receive data from the first personal-storage device indicative of personal preferences of the first user, and wherein selection of which content to be presented is based on the received data indicative of the personal preferences.

34. A system comprising:
a computer;
a first display operatively coupled to the computer;
means, operatively coupled to the computer, for receiving data from a storage device indicative of past personal service and including a digital photographic image pertaining to a past service delivery to a particular first user, and for receiving input as to a present service desired by the first user;
means for displaying on the first display the image for the first user and a first service provider; and
means for selecting and presenting, at the first display, first multimedia content in a sequence based on timing and performance of the personal service delivery to the first user.

35. The system of claim 34, further comprising:
a second display operatively coupled to the computer;
means, operatively coupled to the computer, for receiving data indicative of past personal service and including a digital photographic image pertaining to a past service delivery to a particular second user, and for receiving input as to a present service desired by the second user;
means for displaying on the second display the image for the second user and a second service provider; and
means for selecting and presenting, at the second display, second multimedia content in a sequence based on timing and performance of the personal service delivery to the second user.

36. The system of claim 34, further comprising means for indicating desired changes for the present service to the first user relative to the past service delivery.

37. The system of claim 34, further comprising means for receiving data indicative of personal preferences of the first user, and wherein the means for selecting and presenting content to be presented makes selections based on the received data indicative of the personal preferences.

38. A computer-readable data structure comprising:
a digital photograph of a hair-styling result;
data indicative of one or more hair-quality characteristics; and
data indicative of entertainment preferences, wherein the digital photograph, data indicative of one or more hair-quality characteristics, and data indicative of entertainment preferences are all correlated to a particular person.

39. The data structure of claim 38, further comprising:
data indicative of one or more skin-quality characteristics; and
data indicative of personal-grooming-product references.

40. A computer-readable medium having instructions stored thereon for causing a suitably-programmed information-processing system to perform a method comprising:
receiving data from a storage device indicative of past personal service and including a digital photographic image pertaining to a past service delivery to a particular first user;
displaying at a first station the image for the first user and a first service provider;
receiving input as to a first present service desired by the first user; and
selecting and presenting, at the first station, first multimedia content in a sequence based on timing and performance of the first personal service delivery.

41. The computer-readable medium of claim 40, further comprising instructions stored thereon such that the method further comprises:
receiving data from a storage device indicative of past personal service and of a digital photographic image pertaining to a past service delivery to a particular second user;
displaying at a first station the image for the second user and a second service provider;
receiving input as to a second present service desired by the second user; and
selecting and presenting, at the second station, second multimedia content in a sequence based on timing and performance of the second personal service delivery.

42. The computer-readable medium of claim 40, further comprising instructions stored thereon such that the method further comprises selecting the first content based on indicated preferences of the first user.

43. The computer-readable medium of claim 40, further comprising instructions stored thereon such that the method further comprises receiving and displaying an indication of changes relative to the past service delivery.

44. A computerized method comprising:
receiving, into a computer, data from a first storage device indicative of past personal service and including a digital photographic image pertaining to a past service delivery to a particular first user;
displaying at a first station the image for the first user and a first service provider;
receiving, into the computer, input as to multimedia preferences for presentation along with a first present service desired by the first user;
presenting under control of the computer multimedia content base on the preference; and
after performance of the first present service, storing under control of the computer a digital photographic image pertaining to the first present service to the first storage device.

45. The method of claim 44, wherein the displaying includes dynamically displaying the image on a computer screen.

46. The method of claim 44, wherein the displaying includes printing the image on a fixed medium.

47. The method of claim 44, wherein the first storage device is a personal storage device suitably small to be handheld, and further comprising removing the personal storage device from the computer to be carried by the first user.

48. The method of claim 44, further comprising:
receiving, into the computer, data from a second storage device indicative of past personal service and of a digital photographic image pertaining to a past service delivery to a particular second user;
displaying under control of the computer at a second station the image for the second user and a second service provider;
receiving input as to a second present service desired by the second user; and
after performance of the second present service, storing under control of the computer a digital photographic image pertaining to the second present service to the second storage device.
